(19) United States
(12) Patent Application Publication
(10) Pub. No.: US 2012/0303359 A1
(43) Pub. Date: Nov. 29, 2012

(54) DICTIONARY CREATION DEVICE, WORD GATHERING METHOD AND RECORDING MEDIUM

(75) Inventors: Hironori Mizuguchi, Minato-ku (JP); Dai Kusui, Minato-ku (JP); Yukitaka Kusumura, Minato-ku (JP)

(73) Assignee: NEC CORPORATION, Tokyo (JP)

(21) Appl. No.: 13/515,135

(22) PCT Filed: Dec. 3, 2010
(86) PCT No.: PCT/JP2010/071696

§ 371 Date: Aug. 7, 2012

(30) Foreign Application Priority Data
Dec. 11, 2009 (JP) 2009-282304

(51) Int. Cl. G06F 17/21

(52) U.S. Cl. 704/10

(57) ABSTRACT

When gathering words through a dictionary growth process, a dictionary growth unit (102) stores information indicating through what process of input and output a word has been gathered in a gathering process memory unit (107). Then, a clustering unit (103) classifies the word that has been gathered by the dictionary growth process into clusters on the basis of information recorded in the gathering process memory unit (107). Next, a type determination unit (104) determines whether a word comprising a cluster is of the same type as a seed word or of a different type, for each cluster into which the word has been classified, on the basis of information recorded in the gather process memory unit (107). In addition, an output unit (105) associates information indicating the gathered word, the cluster to which the word belongs and whether the cluster is of the same type as the seed word or of a different type, and displays such.

### TECHNICAL FIELD

The present invention relates to a dictionary creation device, a word gathering method and a recording medium.

### BACKGROUND ART

A dictionary creation method has been known in which a dictionary is created by inputting multiple similar words from document data, Web pages and/or the like using a small number of similar words. A dictionary in this sense is a collection of similar words having a common superordinate concept.

One example of the above-described dictionary creation method is disclosed in Non-Patent Literature 1. An overview of this dictionary creation method is shown below.

First, a small number of words to be used in gathering are input. Below, these words input initially are called seed words. Next, Web pages containing the seed words are gathered using a Web search engine. Next, a pattern is created that divides the seed words from other words from the gathered Web pages. Then words are extracted from the Web pages using this pattern and are added to the seed words. From when the seed words are input until the words are extracted is called a turn. Furthermore, Web pages are further gathered using the seed words to which the words have been added. After this is repeated for a number of turns, the extracted words are output as a collection (dictionary) of words similar to the seed words.

With this kind of dictionary creation method, words that are newly added to the seed words in some cases are words of a different type from the seed words. For example, when creating a dictionary of restaurant names by inputting restaurant name seed words, in some cases words such as ramen shop names or noodle shop names which are contained in the same document and have a similar pattern could be newly added to the seed words.

In such cases it is known that the accuracy of the dictionary deteriorates because from these different-type words, words of an even more different type could be added successively to the seed words, causing large numbers of words differing in type from the seed words to be gathered.

In order to avoid such circumstances, the frequency of words extracted on each turn is found, only words having greater than a prescribed degree of confidence are added to the seed words, and these are used on subsequent turns. For example, a statistical amount based on the pattern occurrence frequency and/or a statistical amount based on the number of words detected from a pattern is used for this degree of confidence. In Non-Patent Literature 1, the number of Web pages from which a word can be extracted using the pattern is used as the degree of confidence, and words having a Web page count from which extracted that is less than a prescribed number are not added to the seed words. Through this, gathering of words of different types is prevented.

### PRIOR ART LITERATURE

### Non-Patent Literature

Non-Patent Literature 1: Hironori Mizuguchi, Hideki Kawai, Masaaki Tsuchida, Dai Kusui: Bootstrapped dictionary growth method using Web knowledge, DEWS2007, 2007

### DISCLOSURE OF INVENTION

### Problems to be Solved by the Invention

When a dictionary is created using the above-described degree of confidence, words of a different type having low degree of confidence (dissimilar words) are excluded from gathering targets and are not added to seed. Accordingly, the user can have absolutely no knowledge of what types of dissimilar words are gathered from seed words, making it impossible to reuse the dissimilar words to gather words of a different group.

In consideration of the foregoing, it is an object of the present invention to provide a dictionary creation device, a word gathering method and a recording medium that enable what kind of dissimilar words were gathered to be appropriately output to a user.

### Means for Solving the Problems

In order to achieve the above object, the dictionary creation device according to a first aspect of the present invention comprises:

an input/output process recording means for recording information indicating the process of inputting and outputting input words and output words output by the input words, in a dictionary growth process for gathering words by repeatedly accepting input of words, outputting words related to the input words from document data, adding to the input words words output until a prescribed condition is satisfied, and outputting words related to the input words from document data;

a cluster classifying means for classifying words that input word or output word becomes the same into same cluster among words gathered by the dictionary growth process based on information recorded in the input/output process recording means;

a similarity determining means for determining whether or not words in a cluster are words of the same type as input words for which input was initially received, for each cluster classified by the cluster classifying means, based on the number of turns required to output each word in the cluster from the input word, by referencing information recorded in the input/output process recording means; and

a gathered word output means for linking together and outputting words gathered by the dictionary growth process, clusters to which the words belong and information indicating whether or not the words comprising the cluster are words of the same type of the input words for which input was initially received.

In addition, the word gathering method according to a second aspect of the present invention comprises:

an input/output process recording step for recording information indicating the process of inputting and outputting input words and output words output by the input words, in a dictionary growth process for gathering words by repeatedly accepting input of words, outputting words related to the input words from document data, adding to the input words words output until a prescribed condition is satisfied, and outputting words related to the input words from document data;

a cluster classifying step for classifying words that input word or output word becomes the same into same cluster among words gathered by the dictionary growth process based on information recorded in the input/output process recording step;

a similarity determining step for determining whether or not words in a cluster are words of the same type as input words for which input was initially received, for each cluster classified by the cluster classifying step, based on the number of turns required to output each word in the cluster from the input word, by referencing information recorded in the input/output process recording step; and

a gathered word output step for linking together and outputting words gathered by the dictionary growth process, clusters to which the words belong and information indicating whether or not the words comprising the cluster are words of the same type of the input words for which input was initially received.

In addition, the recording medium according to a third aspect of the present invention is a computer-readable recording medium on which is recorded a program that causes a computer to function as:

an input/output process recording means for recording information indicating the process of inputting and outputting input words and output words output by the input words, in a dictionary growth process for gathering words by repeatedly accepting input of words, outputting words related to the input words from document data, adding to the input words words output until a prescribed condition is satisfied, and outputting words related to the input words from document data;

a cluster classifying means for classifying words that input word or output word becomes the same into same cluster among words gathered by the dictionary growth process based on information recorded in the input/output process recording means;

a similarity determining means for determining whether or not words in a cluster are words of the same type as input words for which input was initially received, for each cluster classified by the cluster classifying means, based on the number of turns required to output each word in the cluster from the input word, by referencing information recorded in the input/output process recording means; and

a gathered word output means for linking together and outputting words gathered by the dictionary growth process, clusters to which the words belong and information indicating whether or not the words comprising the cluster are words of the same type of the input words for which input was initially received.

### Efficacy of the Invention

With the present invention, words gathered in dictionary construction are clustered and a determination is made for each cluster as to whether or not these are words of the same type as the words initially input. Accordingly, it is possible for what kind of dissimilar words were gathered to be appropriately output to a user.

### BRIEF DESCRIPTION OF DRAWINGS

FIG. 1 is a drawing showing the composition of a dictionary creation device according to a first preferred embodiment of the present invention;

FIG. 2 is a drawing showing an exemplary composition of information recorded in a gathering process memory unit;

FIG. 3 is a drawing showing an exemplary composition of information recorded in a gathered word memory unit;

FIG. 4 is a flowchart for explaining actions of the dictionary creation process;

FIG. 5 is a flowchart for explaining actions of the dictionary growth process;

FIG. 6 is a flowchart for explaining actions of a clustering process;

FIG. 7 is a graph illustrating the input/output relationship between words;

FIG. 8 is a flowchart for explaining actions of a similarity determination process;

FIG. 9 is a drawing showing the composition of a dictionary creation device according to a second preferred embodiment of the present invention;

FIGS. 10A and 10B are drawing showing an exemplary composition of information recorded in the word group memory unit;

FIG. 11 is a flowchart for explaining actions of the dictionary creation process;

FIG. 12 is a flowchart for explaining actions of a word group update process;

FIG. 13 is a drawing showing the composition of a dictionary creation device according to a third preferred embodiment of the present invention;

FIG. 14 is a drawing showing an exemplary composition of information recorded in a gathered word memory unit; and

FIG. 15 is a block diagram showing one example of the physical composition when a dictionary creation device according to the preferred embodiments is implemented in a computer.

### MODE FOR CARRYING OUT THE INVENTION

Below, the preferred embodiments of the present invention are described in detail with reference to the drawings. The present invention is not limited by the below-described preferred embodiments and drawings, for the below-described preferred embodiments and drawings can be altered without altering the scope of the present invention. In addition, same or corresponding components in the drawings are labeled with the same reference numbers.

In addition, in the present invention a dictionary is a collection of similar words having a common superordinate concept.

### First Embodiment

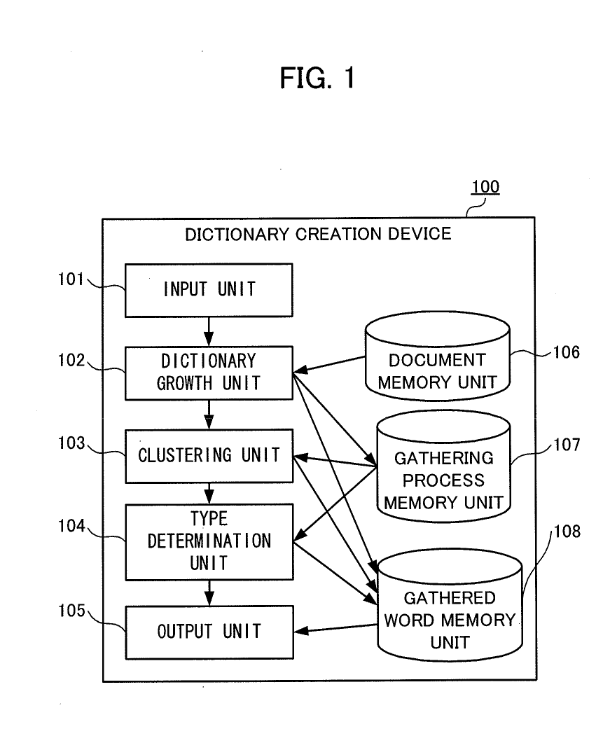

A dictionary creation device 100 according to a first preferred embodiment of the present invention will be described. As shown in FIG. 1, the dictionary creation device 100 is provided with an input unit 101, a dictionary growth unit 102, a clustering unit 103, a type determination unit 104, an output unit 105, a document memory unit 106, a gathering process memory unit 107 and a gathered word memory unit 108.

The input unit 101 is composed of a keyboard, mouse and/or the like. Via the input unit 101, a user inputs words (seed words) as samples for creating a dictionary (collection of similar words).

The dictionary growth unit 102 accomplishes a dictionary growth process that gathers words similar to the seed words from documents stored in the document memory unit 106, using a conventional method such as that described in Non-Patent Literature 1. In addition, in this dictionary growth process the dictionary growth unit 102 stores in the gathering process memory unit 107 information indicating by what kind of process the words have been gathered. Details of the dictionary growth process accomplished by the dictionary growth unit 102 are described below.

The clustering unit 103 classifies (clusters) words gathered by the dictionary growth unit 102 into multiple clusters based on the information stored in the gathering process memory unit 107. Details of the process accomplished by the clustering unit 103 are described below.

The type determination unit 104 determines whether or not words comprising a cluster are the same type of words as the seed words, by referencing information stored in the gathering processing memory unit 107, with a cluster and words contained in that cluster as input. Details of the process accomplished by the type determination unit 104 are described below.

The output unit 105 outputs various information. For example, the output unit 105 outputs (displays) words gathered by the dictionary growth process, appending information indicating whether this is of the same type or a different type from the seed word, for each classified cluster.

The document memory unit 106 stores data defining various documents that are targets of word gathering by the dictionary growth unit 102. An ID (document ID) is attached to the data of each document.

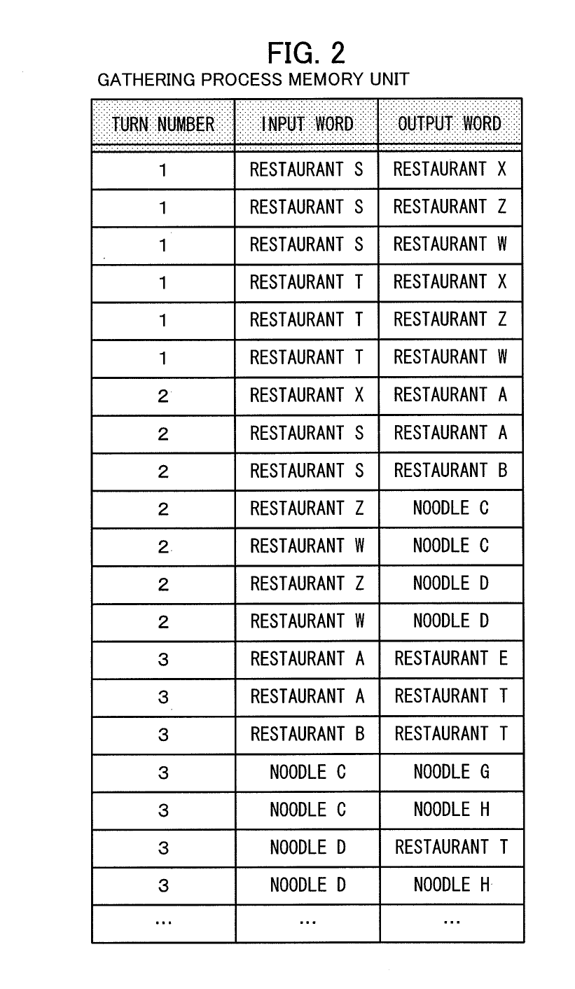

In the dictionary growth process, information indicating by what kind of input and output process a word was gathered is stored in the gathering process memory unit 107. Specifically, as shown in FIG. 2, for each turn in the dictionary growth process the turn number of that turn, the input word input by that turn and output words output by a pattern created from that input word are stored associated with each other in the gathering process memory unit 107.

For example, from the lead entry in FIG. 2, on the first turn on the dictionary growth process “Restaurant X” is extracted by a pattern created from “Restaurant S”.

Returning to FIG. 1, the gathered words and cluster IDs indicating into which clusters the words have been classified are stored, associated with each other, in the gathered word memory unit 108. In addition, to each cluster information is appended indicating whether the words comprising the cluster are words of the same type as the seed word (when the seed word itself is contained in that cluster, this is considered the same type), or words of a different type.

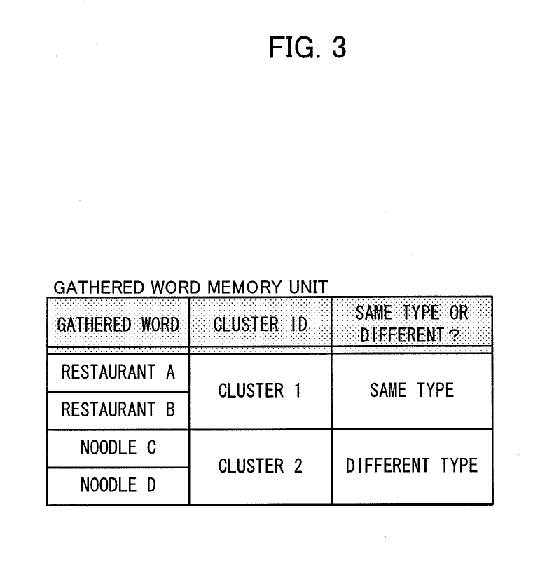

For example, from FIG. 3 “Restaurant A” and “Restaurant B” are classified into Cluster 1, and in addition it can be seen that Cluster 1 is composed of words of the same type as the seed word. Similarly, “Noodle C” and “Noodle D” are classified into Cluster 2, and in addition it can be seen that Cluster 2 is composed of words of a different type from the seed word.

Next, actions of processes implemented by the dictionary creation device 100 will be described.

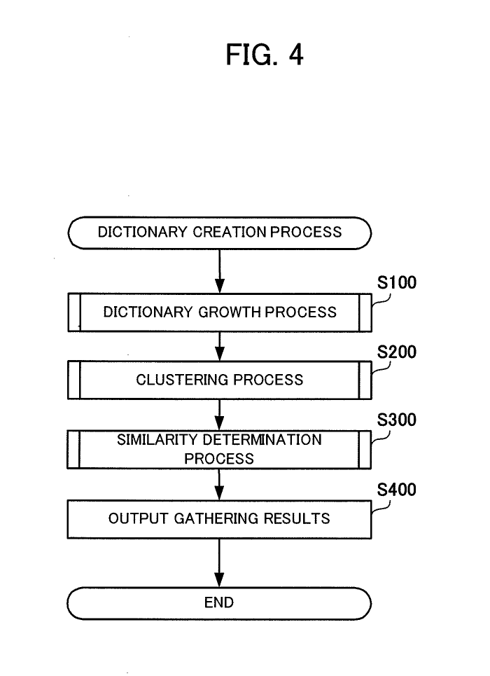

The user operates the input unit 101 to input one or multiple words (seed words) as samples for creating a dictionary (collection of similar words). Furthermore, the user directs that a dictionary be created based on the input seed words. The dictionary creation device 100 accomplishes the dictionary creation process shown in FIG. 4 in accordance with this directive operation.

When the dictionary creation process is started, first the dictionary growth unit 102 accomplishes a dictionary growth process using a conventional method, and words related to the input seed words are gathered (step S100).

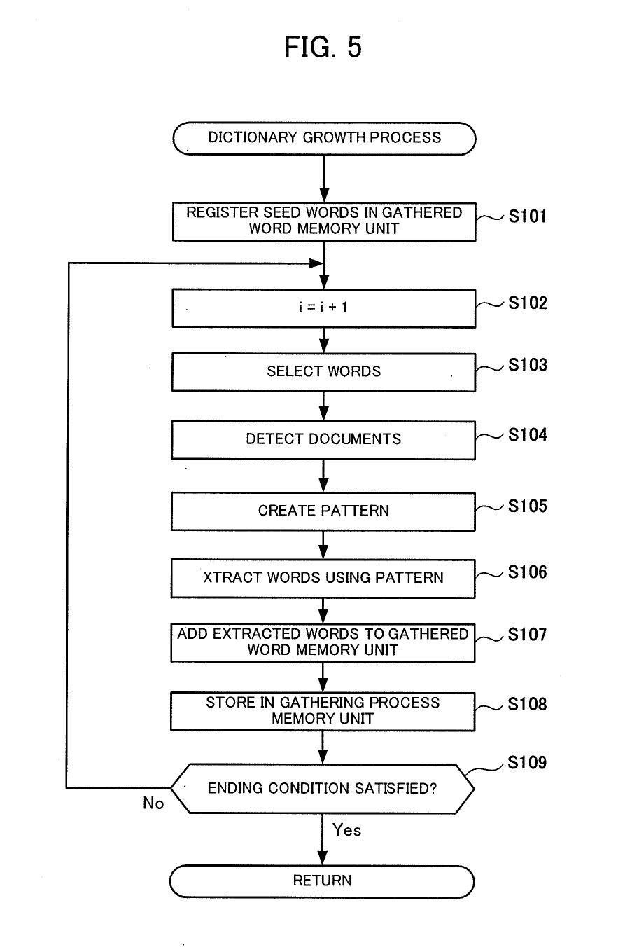

Details of the dictionary growth process (step S100) will be described with reference to the flowchart in FIG. 5. When the dictionary growth process is started, first the dictionary growth unit 102 registers, in the gathered word memory unit 108, seed words input by the user (step S101). Furthermore, the dictionary growth unit 102 increments by 1 a counter i (initial value 0) indicating the turn number (step S102).

Next, the dictionary growth unit 102 randomly selects a prescribed number of words from among the words stored in the gathered word memory unit 108 (step S103). Then, the dictionary growth unit 102 detects documents in which the selected seed words are contained, from among the documents stored in the document memory unit 106 (step S104). Here, it is fine to detect only documents containing all of the selected seed words, or to select documents containing a prescribed number of seed words from among the selected seed words.

Next, the dictionary growth unit 102 identifies positions where the seed words selected in step S103 appear in the detected documents and creates a pattern dividing the seed words and parts others than these (step S105). For example, it would be fine to utilize as a pattern a character string of a prescribed number before and after the area where the seed word appears in the document.

Next, the dictionary growth unit 102 extracts words matching the created pattern from the documents stored in the document memory unit 106 (step S106). Then the dictionary growth unit 102 adds the extracted words to the gathered word memory unit 108 (step S107).

Next, the dictionary growth unit 102 coordinates and stores information indicating the current turn number (that is to say, the value of the counter i), each word (input word) selected in step S103, and the words (output words) extracted in step S106 through patterns created from the input words, in the gathering process memory unit 107 (step S108).

Next, the dictionary growth unit 102 determines whether or not a prescribed ending condition for causing dictionary growth to end has been satisfied (step S109). As the ending condition, it is possible to utilize an arbitrary condition such as the number of words recorded in the gathered word memory unit 108 reaching a prescribed number, or the turn number reaching a prescribed number. In order for the words gathered in the below-described clustering process to be appropriately clustered, it is preferable to utilize an ending condition such that gathering of words is repeatedly executed at least two or more turns.

When it is determined that the ending condition has not been satisfied (step S109: No), the dictionary growth unit 102 repeats steps S102 to S108, and the process of gathering words from seed words to which new words are added is repeatedly accomplished.

When it is determined that the ending condition has been satisfied (step S109: Yes), the dictionary growth unit 102 ends the dictionary growth process and transitions the process to the clustering unit 103.

Returning to FIG. 4, next the clustering unit 103 accomplishes a clustering process that clusters words gathered by the dictionary growth process into clusters (step S200).

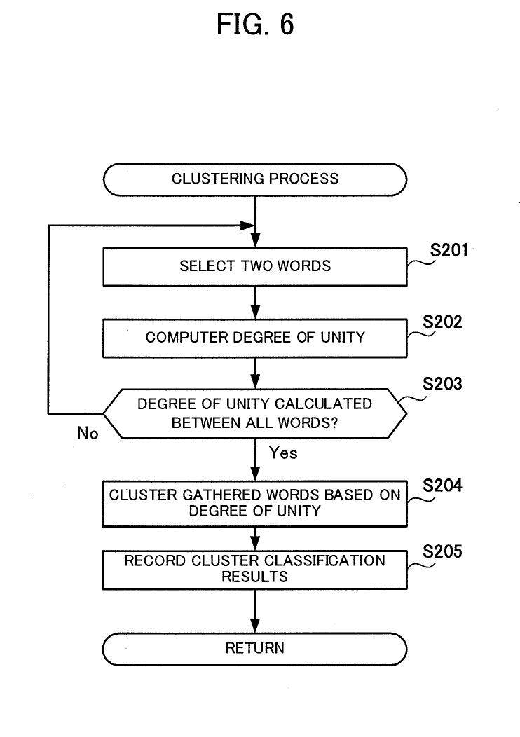

FIG. 6 is a flowchart showing details of the clustering process (step S200). When the clustering process begins, first the clustering unit 103 selects two words for which the degree of unity between words has not yet been calculated from the gathered word memory unit 108 (step S201).

Next, the clustering unit 103 calculates the degree of unity between the two selected words on the basis of the information stored in the gathering process memory unit 107 (step S202).

The degree of unity between the words is an indicator that becomes larger between words which have common words as inputs or between words that output common words in the above-described dictionary growth process. For example, it is possible to calculate as the degree of unity between two words the sum of the ratio of the common words by which the two words were input out of the words by which the two words were respectively input, and the ratio of the common words the two words output out of the words the two words respectively output.

More specifically, taking the degree of unity between two words a and b to be Sim(a,b), the degree of unity can be calculated from the following formula.

Sim(a,b)=Sim_in(a,b)+sim_out(a,b).

In this equation, Sim_in(a,b) is a value indicating the ratio of the words input from common words out of the words respectively input into the words a and b. Sim_in(a,b) can be found as (number of common words input into both word a and word b)/((number of words input into word a)+(number of words input into word b)).

In addition, Sim_out(a,b) is a value indicating the ratio of the words outputting common words out of the words the two words a and b respectively output. Sim_out(a,b) can be found as (number of common words output from both word a and word b)/((number of words output by word a)+(number of words output by word b)).

Next, the clustering unit 103 determines whether or not the degree of unity has been calculated for all sets of seed words stored in the gathered word memory unit 108 (step S203).

When the degree of unity has not been calculated for all sets of seed words (step S203: No), the clustering unit 103 selects two seed words for which the degree of unity has not been calculated and repeats the process of calculating the degree of unity (steps S201 and S202).

When the degree of unity has been calculated for all sets of seed words (step S203: Yes), the clustering unit 103 accomplishes clustering using a commonly known clustering method such as a shortest distance method, longest distance method or a group average method, with the calculated degree of unity as the degree of similarity, and classifies the words stored in the gathered word memory unit 108 into multiple clusters (step S204).

Furthermore, the clustering unit 103 records the results of clustering (step S205). Specifically, the clustering unit 103 appends a cluster ID to each word stored in the gathered word memory unit 108 so that the results of classification into clusters are reflected. With this, the clustering process ends.

In this manner, through the clustering process the degree of unity between gathered words is calculated and the gathered words are classified into multiple clusters on the basis of the calculated degree of unity.

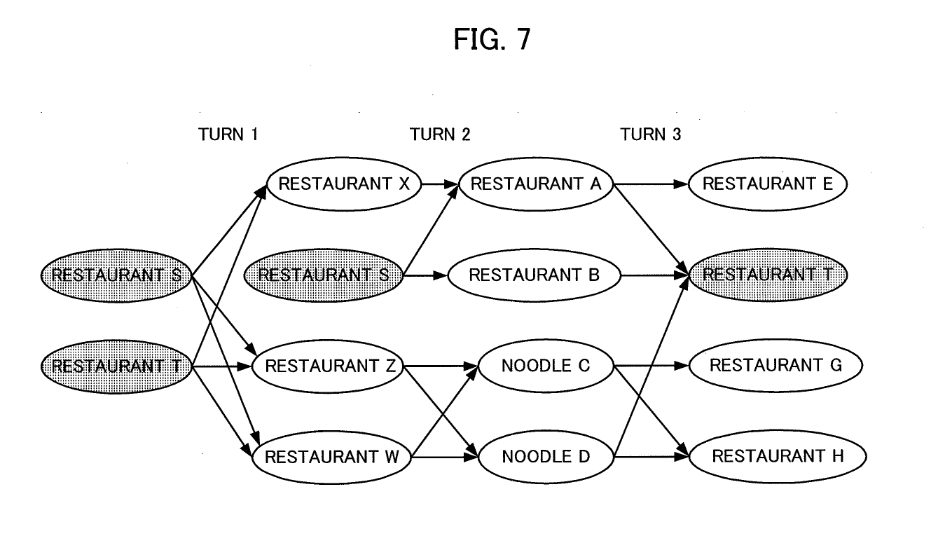

A specific example will now be given and explained for the above-described clustering process. FIG. 7 is a drawing graphically showing the relationship among the input and output between words from turn 1 to turn 3 of the dictionary growth process when the information shown in FIG. 2 is stored in the gathering process memory unit 107. In FIG. 7, the words are expressed by nodes and are linked by arcs (arrows) in the direction of output words from input words. For example, from FIG. 7 it can be seen that the word “Restaurant A” was extracted by a pattern created from “Restaurant X” and “Restaurant S” in turn 2. In addition, it can be seen that in turn 3 “Restaurant E” and “Restaurant T” were extracted by a pattern created from the word “Restaurant A”.

Let us consider the case of calculating the degree of unity Sim(A,B) between “Restaurant A” and “Restaurant B.”

Words input to “Restaurant A” are “Restaurant X” and “Restaurant S,” and the word input to “Restaurant B” is “Restaurant S.” Furthermore, of these “Restaurant S” is input to both “Restaurant A” and “Restaurant B.” Accordingly, Sim_in(A,B) is ⅓. In addition, words output by “Restaurant A” are “Restaurant E” and “Restaurant T,” and the word output by “Restaurant B” is “Restaurant T.” Furthermore, of these “Restaurant T” is output from both “Restaurant A” and “Restaurant B.” Accordingly, Sim out(A,B) is ⅓. Accordingly, the degree of unity is calculated as Sim(A,B)=Sim_in(A,B) +Sim_out(A,B)=⅓+⅓=⅔.

Similarly, the degree of unity among other words is calculated as follows:

The degree of unity between restaurant A and noodle C: Sim(A,C)=Sim_in(A,C)+Sim_out(A,C)=0+0=0.

The degree of unity between restaurant A and noodle D: Sim(A,D)=Sim_in(A,D)+Sim_out(A,D)=0+0=0.

The degree of unity between restaurant B and noodle C: Sim(B,C)=Sim_in(B,C)+Sim_out(B,C)=0+0=0.

The degree of unity between restaurant B and noodle D: Sim(B,D)=Sim_in(B,D)+Sim_out(B,D)=0+⅓=⅓.

The degree of unity between noodle C and noodle D: Sim(C,D)=Sim_in(C,D)+Sim_out(C,D)= 2/4+¼=¾.

Furthermore, clustering is accomplished using a commonly known clustering method with this degree of unity among the words as the degree of similarity. For example, from this degree of unity two clusters are created, namely Cluster 1 {Restaurant A, Restaurant B} and Cluster 2 {Noodle C, Noodle D}, and as shown in FIG. 3, the cluster ID is appended to these words stored in the gathered word memory unit 108.

Returning to FIG. 4, the type determination unit 104 accomplishes a similarity determination process that determines whether or not the clusters classified by the clustering process are composed of words similar to the words (seed words) input initially (step S300).

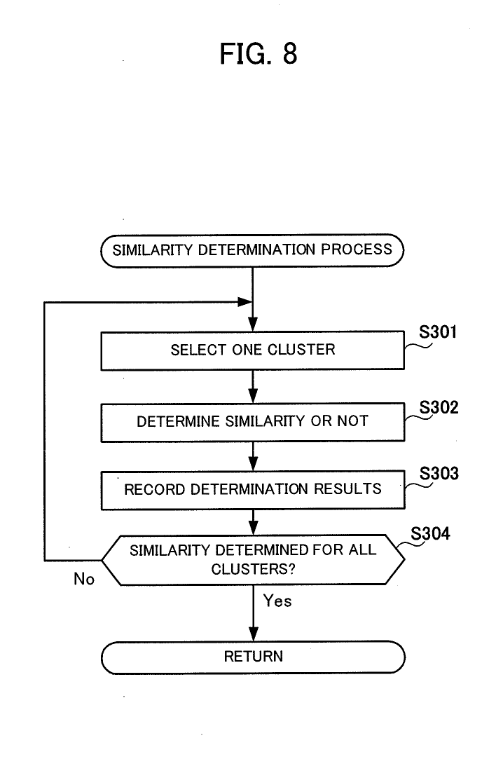

FIG. 8 is a flowchart showing details of the similarity determination process (step S300). First, the type determination unit 104 selects one cluster in which similarity determination has not been accomplished and words contained in that cluster, from the gathered word memory unit 108 (step S301).

Next, the type determination unit determines whether or not the words in the selected cluster are similar words to the words (seed words) input initially, referencing the gathering process memory unit 107 (step S302). This determination may be accomplished on the basis of the proximity of each word in the cluster to the seed words.

Specifically, the type determination unit 104 may calculate the number of turns required to output each word in the cluster from the seed words and the number of turns required for each word in the cluster to output the seed words, and make a determination of similarity or dissimilarity based on the calculated number of turns.

Next, the type determination unit 104 stores the determination results in the gathered word memory unit 108 (step S303).

Next, the type determination unit 104 determines whether or not the above-described similarity determination has been implemented for all clusters stored in the gathered word memory unit 108 (step S304).

When there is a cluster for which the type determination is unimplemented (step S304; No), the type determination unit 104 selects that cluster and repeats the process to making a similarity determination (step S301 to S303).

When there is no cluster for which type determination is unimplemented (step S304: Yes), the similarity determination process ends.

In this manner, by implementing the similarity determination process it can be determined whether the words comprising a cluster are words of the same type or different types from the seed words, for each cluster.

Next, an explanation is given citing a specific example for the above-described similarity determination process.

As an assumption, suppose that the input/output relationships shown in FIG. 7 are obtained from information recorded in the gathering process memory unit 107 shown in FIG. 2. In addition, suppose that “Restaurant A” and “Restaurant B” are classified in Cluster 1, and “Noodle C” and “Noodle D” are classified in Cluster 2. In addition, suppose that the threshold value used in judging similarity is 0.6. In FIG. 7, the seed words “Restaurant S” and “Restaurant T” are indicated by shading.

First, an explanation is given for a similarity determination in Cluster 1.

The word “Restaurant A” in Cluster 1 is output from the seed word “Restaurant S” in as short as one turn through the route “Restaurant S→Restaurant A”. Or, “Restaurant A” outputs the seed word “Restaurant T” in as short as one turn through the route “Restaurant A→Restaurant T”. Consequently, the inverse 1 of the shortest number of turns, 1, is the value expressing the proximity of “Restaurant A” to the seed words.

Similarly, the word “Restaurant B” in Cluster 1 is output from the seed word “Restaurant S” in as short as one turn through the route “Restaurant S→Restaurant B”. Or, “Restaurant B” outputs the seed word “Restaurant T” in as short as one turn through the route “Restaurant B→Restaurant T”. Consequently, the inverse 1 of the shortest number of turns, 1, is the value expressing the proximity of “Restaurant B” to the seed words.

Accordingly, the proximity to the seed words in Cluster 1 as a whole is taken from the average of the proximities of “Restaurant A” and “Restaurant B”, and becomes 1. Because this value is greater than the threshold value 0.6, Cluster 1 is determined to have similarity, and that result is stored in the gathered word memory unit 108.

Next, an explanation is given for a similarity determination in Cluster 2.

The word “Noodle C” in Cluster 2 is output from the seed word “Restaurant S” or the seed word “Restaurant T” in as short as two turns through the route “Restaurant S→Restaurant Z→Noodle C” or “Restaurant T→Restaurant W→Noodle C”. Consequently, the inverse 0.5 of the shortest number of turns, 2, is the value expressing the proximity of “Noodle C” to the seed words.

Similarly, word “Noodle D” in Cluster 2 is output from the seed word “Restaurant S” or the seed word “Restaurant T” in as short as two turns through the route “Restaurant S→Restaurant Z→Noodle D” or “Restaurant T→Restaurant W→Noodle D”. Consequently, the inverse 0.5 of the shortest number of turns, 2, is the value expressing the proximity of “Noodle D” to the seed words.

Accordingly, the proximity to the seed words in Cluster 2 as a whole is taken from the average of the proximities of “Noodle C” and “Noodle D”, and becomes 0.5. Because this value is less than the threshold value 0.6, Cluster 2 is determined to have dissimilarity, and that result is stored in the gathered word memory unit 108.

Returning to FIG. 4, next the output unit 105 outputs (displays) the words gathered, classified into clusters and determined to be similar or dissimilar to the seed words, linking to this information, with reference to the gathered word memory unit 108 (step S400). For example, the output unit outputs “Cluster 1 {Restaurant A, Restaurant B}: similar; Cluster 2 {Noodle C, Noodle D}:dissimilar” and/or the like. With this, the dictionary creation process ends.

In this manner, with this preferred embodiment the words gathered by the dictionary growth process are classified into clusters. In addition, determinations are made as to whether or not each cluster is composed of words of the same type as the seed words, and this is output. Accordingly, it is possible to suitably output to the user what dissimilar types of words have been gathered.

### Second Embodiment

A dictionary creation device 200 according to a second preferred embodiment is the composition of the dictionary creation device 100 of the first preferred embodiment to which a word selection unit 201, a re-execution unit 202 and a word group memory unit 203 have been added. In the below description and drawings, parts that are the same as in the first preferred embodiment are labeled with the same reference numbers. In addition, a detailed explanation of constituent elements that are the same as the first preferred embodiment is the same as the above explanation for the first preferred embodiment, so detailed explanation is omitted here.

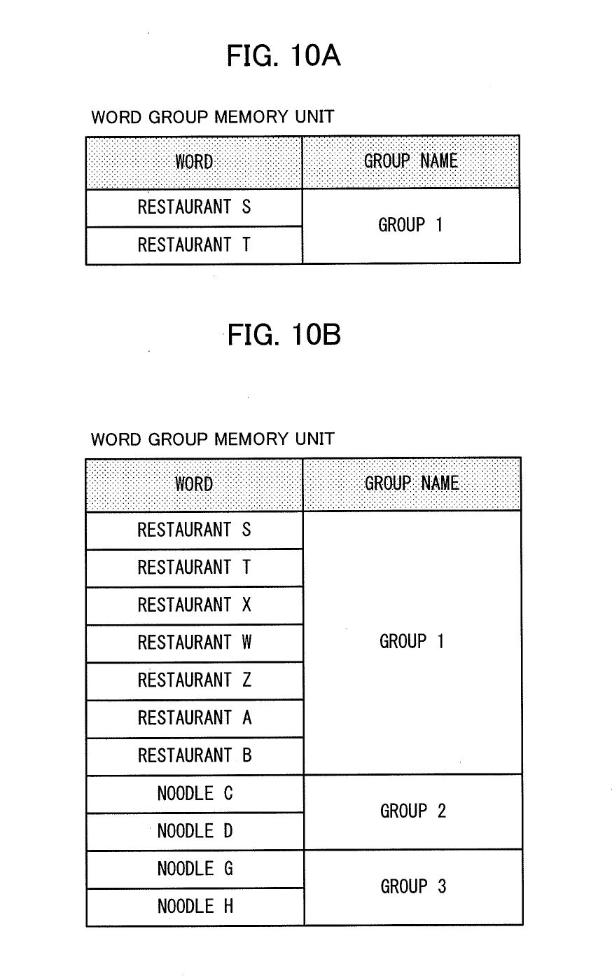

As shown in FIGS. 10A and 10B, gathered words and groups names, which are identifying information for groups to which these words belong, are stored, associated with each other, in the word group memory unit 203.

The word selection unit 201 selects one ungathered group by referencing the word group memory unit 203 and selects a prescribed number of words from the selected group. Furthermore, the word selection unit 201 directs the dictionary growth unit 102 to execute the dictionary growth process using the selected words as seed words.

The re-execution unit 202 appends a group name to the words that have been gathered, classified into clusters and determined to be either similar or dissimilar to the seed words, and adds such to the word group memory unit 203. Furthermore, when there is a group for which gathering has not yet been accomplished, the re-execution unit 202 directs the word selection unit 201 to select words from that group.

The various other parts (the input unit 101, the dictionary growth unit 102, the clustering unit 103, the type determination unit 104, the output unit 105, the document memory unit 106, the gathering process memory unit 107 and the gathered word memory unit 108) accomplish the same processes as in the first preferred embodiment, so explanation is omitted here. However, the seed words that the dictionary growth unit 102 uses as the origin of word gathering are words selected by the word selection unit 201.

Next, actions of the process implemented by the dictionary creation device 200 will be explained. Multiple words are recorded as Group 1 in the word group memory unit 203. In addition, suppose that this Group 1 is the below-described gathering-incomplete group. In addition, suppose that groups other than Group 1 are not recorded at the present time.

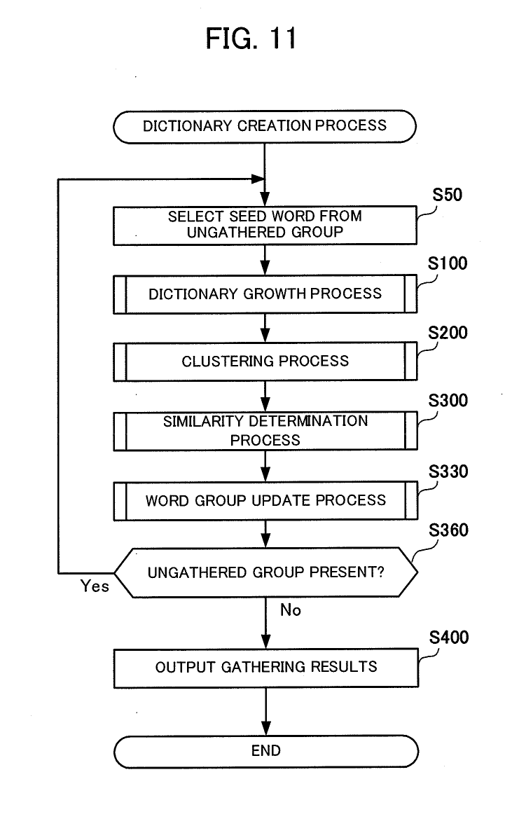

First, the user operates the input unit 101 to command creation of a dictionary. In accordance with this command operation, the dictionary creation device 200 accomplishes the dictionary creation process shown in FIG. 11.

When the dictionary creation process is started, the word selection unit 201 selects a preset number of words as seed words from among the words contained in the ungathered group (that is to say, Group 1), with reference to the word group memory unit 203 (step S50).

Next, the dictionary growth unit 102 accomplishes the dictionary growth process the same as in the first preferred embodiment and gathers words of the same type as the seed words (step S100). Here, the words selected in step S50 are made seed words.

Next, the clustering unit 103 accomplishes the clustering process the same as in the first preferred embodiment, and classifies the words gathered by the dictionary growth process into clusters (step S200).

Next, the type determination unit 104 accomplishes the similarity determination process the same as in the first preferred embodiment, and determines whether or not the cluster is composed of words of the same type as the seed words (step S300).

Next, the re-execution unit 202 accomplishes a word group updating process that records and groups the words comprising a cluster in the word group memory unit 203 for each cluster that has been determined to be similar or dissimilar to the seed words (steps S330).

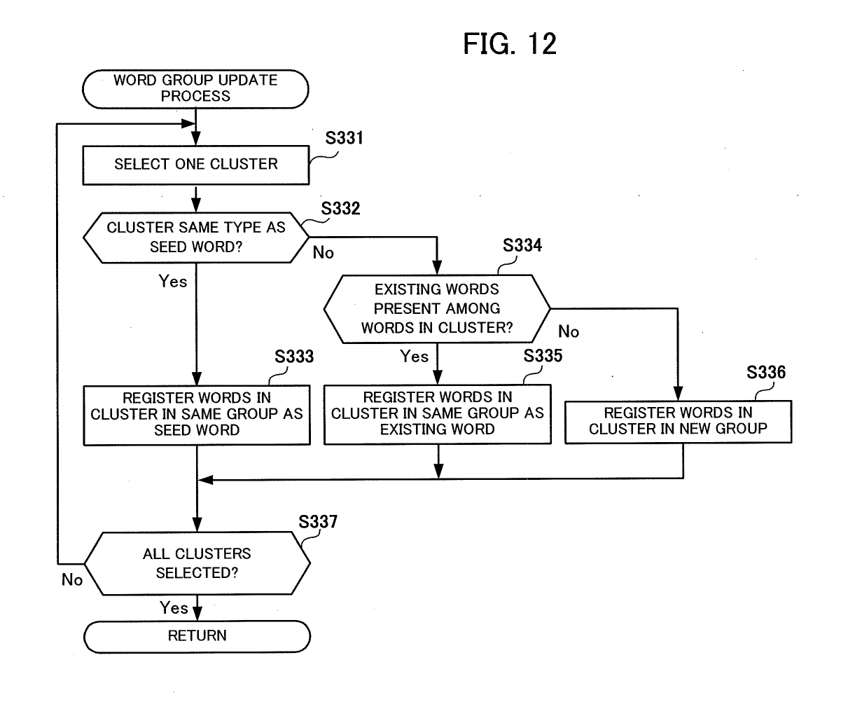

FIG. 12 shows details of the word group updating process. When the word group updating process is started, first the re-execution unit 202 selects one unprocessed cluster from among the clusters that were clustered in the above-described step S200 (step S331).

Next, the re-execution unit 202 determines whether or not the selected clusters are composed of words similar to the seed words, by referencing the results of the similarity determination process of step S300 (step S332).

When the cluster is similar to the seed words (step S332: Yes), the re-execution unit 202 appends the same group name as the seed words and registers the words in the selected cluster in the word group memory unit 203 (step S333). The unit then transitions to the process in step S337.

When the cluster is dissimilar to the seed words (step S332: No), the re-execution unit 202 determines whether or not there are words (existing words) already registered in the word group memory unit 203 among the words in the selected cluster, by referencing the word group memory unit 203 (step S334).

When it is determined that there is an existing word (step S334: Yes), the re-execution unit 202 registers the words in the selected cluster in the word group memory unit 203 by appending the same group name as the group name appended to that existing word (step S335). Then, the process moves to step S337.

When it is determined that there are no existing words (step S334: No), the re-execution unit 202 registers the words in the selected cluster in the word group memory unit 203 by appending a newly issued group name (step S336). Then, the process moves to step S337.

In step S337, the re-execution unit 202 makes a determination as to whether or not the process of registering words within clusters in the word group memory unit 203 has been accomplished for all clusters that have been clustered.

When there is a cluster for which the process of registering in the word group memory unit 203 has not yet been accomplished (step S337: No), the re-execution unit 202 selects the unprocessed cluster and repeats the series of processes (step S331 to S336) for registering the words within the cluster in the word group memory unit 203.

When the process of registering words in the word group memory unit 203 has been accomplished for all clusters (step S337: Yes), the word group updating process ends.

Returning to FIG. 11, next the re-execution unit 202 determines whether or not there are groups (hereafter called gathering-incomplete groups) for which word gathering has not yet been completed (step S360).

For example, groups satisfying any of conditions a) through d) shown below may be determined to be gathering-incomplete groups.

a) Groups in which the number of words in the group has not reached a set number.

b) Groups in which the dictionary growth process using words within the group as seed words has not been executed a set number of times.

c) Groups in which the number of words newly added to the group is at least a set number.

d) Groups matching conditions made by combining a) through c) with a ratio having a prescribed weighting.

When there are gathering-incomplete groups (step S360: Yes), the re-execution unit 202 directs the word selection unit 201 to select seed words from a first gathering-incomplete group. Furthermore, the process of gathering words from the seed words, clustering such, determining whether or not these are similar to or dissimilar from the seed words, and grouping the words is repeated (step S50 to S330).

When there are no gathering-incomplete groups (step S360: No), the output unit 105 outputs the gathered words. However, in addition to the cluster to which a word belongs and information indicating whether or not that cluster is of the same type as the seed words, the group name to which the word belongs is acquired from the word group memory unit 203. Then, this information is output (displayed), linked to the gathered words. With this, the dictionary creation process ends.

Next, a specific example will be given and explained for the above-described dictionary creation process. As a premise, supposed that only Group 1, which is a gathering-incomplete group, is stored in the word group memory unit 203.

Accordingly when the dictionary creation process is started in this state, first the words “Restaurant S” and “Restaurant T” in Group 1 are selected (step S50). Next, a dictionary growth process is executed using “Restaurant S” and “Restaurant T” as seed words, and words are gathered (step S100). Furthermore, the gathered words are clustered based on the degree of unity (step S200), and in each cluster a determination is made as to whether or not the words are of the same type as the seed words “Restaurant S” and “Restaurant T” (step S300). Here, suppose that Clusters 1-5 shown below were created.

Cluster 1 (similar): “Restaurant A”, “Restaurant B”

Cluster 2 (dissimilar): “Noodle C”, “Noodle D”

Cluster 3 (similar): “Restaurant X”, “Restaurant Z”, “Restaurant W”

Cluster 4 (similar): “Restaurant S”, “Restaurant T”

Cluster 5 (dissimilar): “Noodle G”, “Noodle H”

Next, a word group updating process is executed for grouping the words in a group and recording these words in the word group memory unit 203, for each of these clusters (step S330). In this case, Cluster 1, Cluster 3 and Cluster 4 are determined to be similar to the seed words, so the words in these clusters are recorded in the word group memory unit 203 as words of Group 1 that are the same as the seed words (step S333).

In addition, Cluster 2 and Cluster 5 are words different from the seed words, and in addition, the words in these clusters are not yet recorded in the word group memory unit 203. Accordingly, the words in Cluster 2 and Cluster 5 are given the new group names Group 2 and Group 3, respectively, and recorded in the word group memory unit 203 (step S336).

Furthermore, ultimately the words in Clusters 1 to 5 are given group names and recorded in the word group memory unit 203, as shown in FIG. 10B.

Next, when there are gathering-incomplete groups, one of these groups (that is to say, Group 2 or Group 3) is selected and the series of processes for accomplishing word gathering using words in the selected group as new seed words is repeated.

In this manner, with the second preferred embodiment, not only is the extent to which dissimilar words are included determined, the same kind of dissimilar words are recorded as a new group. Furthermore, more words can be gathered using the words in that group as seed words. Through this, it is possible to accomplish word gathering for separate groups whose words are similar to seed words provided initially.

### Third Embodiment

With the second preferred embodiment, a dictionary growth process was accomplished using as seed words a prescribed number of words selected at random from words in the group. Consequently, it is not possible to appropriately gather words in accordance with various circumstances, such as when the intent is to acquire a large number of words with a small number of gathering turns, or when the intent is to increase precision with which the words gathered despite numerous gathering turns resemble the seed words. With this preferred embodiment, it is possible to appropriately gather words in accordance with various circumstances.

The dictionary creation device 300 according to the third preferred embodiment has the word selection unit 201 of the dictionary creation device 200 of the second preferred embodiment replaced by a second word selection unit 301. In addition, a unity-between-words memory unit 302 is newly added. In the below description and drawings, parts that are the same as in the first preferred embodiment and the second preferred embodiment are labeled with the same reference numbers. In addition, a detailed explanation of constituent elements that are the same as the first preferred embodiment and the second preferred embodiment is the same as the above explanation for the first preferred embodiment and second preferred embodiment, so detailed explanation is omitted here.

The second word selection unit 301 selects one ungathered group and selects multiple words from the words contained in the selected group, by referencing the word group memory unit 203. In this case, the second word selection unit 301 gives priority to selecting words whose degree of unity matches prescribed conditions.

Here, the aforementioned prescribed condition is a condition such as “selecting for 75% words in the group in order from highest degree of unity with the remaining 25% selected in order from lowest degree of unity.” When only words with high degree of unity are selected, only words that frequently occur are gathered, so the accuracy of words gathered that are similar to the seed words increases, but the number of gathered words declines, making gathering efficiency deteriorate. Accordingly, when word gathering that emphasizes gathering efficiency more than gathering precision is accomplished, it is preferable to utilize conditions such as the aforementioned.

In addition, when the intent is to accomplish word gathering emphasizing gathering precision more than gathering efficiency, it is preferable to utilize conditions such as “selecting in order from highest degree of efficiency from words in the group”.

The condition information defining the conditions of this word selection is stored in advance in the memory unit of the dictionary creation system 300.

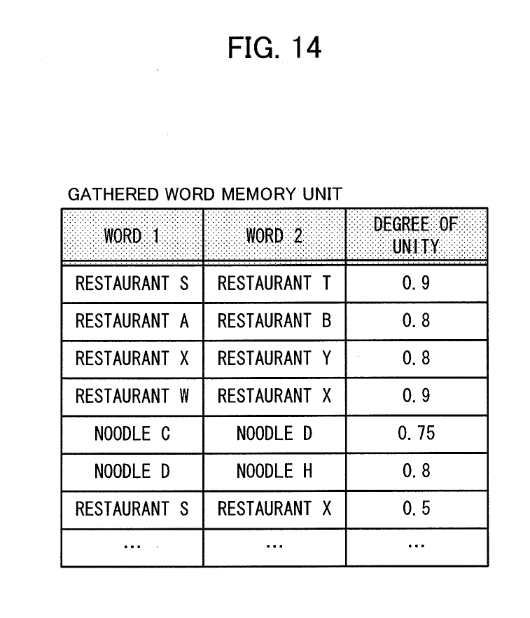

The unity-between-words memory unit 302 stores the degree of unity between words computed by the clustering unit 103. Specifically, as shown in FIG. 14, two words and the degree of unity between those two words are stored associated with each other in the unity-between-words memory unit 302. For example, from the lead entry in FIG. 14, it can be seen that the degree of unity between “Restaurant S” and “Restaurant T” is 0.9.

The various other parts (the input unit 101, the dictionary growth unit 102, the clustering unit 103, the type determination unit 104, the output unit 105, the document memory unit 106, the gathering process memory unit 107, the gathered word memory unit 108, the re-execution unit 202 and the word group memory unit 203) accomplish the same processes as in the second preferred embodiment, so explanation is omitted here.

Next, actions of the process implemented by the dictionary creation device 300 will be explained. Suppose that conditions for selecting words from a group relating to the degree of unity to be utilized when gathering have been set beforehand. In addition, suppose that four words are selected from a group.

The user operates the input unit 101 and directs creation of a dictionary. In accordance with this directive operation, the dictionary creation device 300 accomplishes the dictionary creation process shown in FIG. 11 the same as in the second preferred embodiment.

First, the second word selection unit 301 selects one ungathered group by referencing the word group memory unit 302, and selects a prescribed number of words (4) as seed words from the words in the selected group on the basis of the prescribed conditions by referencing the unity-between-words memory unit 302.

For example, consider the case in which the condition set is that “selection is made in order from highest degree of unity for 75% and in order from lowest degree of unity for the remaining 25% from words in the group.” That is to say, three words having a high degree of unity and one word having a low degree of unity are selected.

In this case, the second word selection unit 301 first selects two words having the highest degree of unity between words from the words in the group. Next, the second word selection unit 301 selects one word with the highest degree of unity with these two words.

Furthermore, the second word selection unit 301 selects one word having a low degree of unity with these three words.

Subsequent processes are the same as in the second preferred embodiment.

That is to say, the dictionary growth unit 102 accomplishes the dictionary growth process for gathering similar words using the four words selected by the second word selection unit 301 as seed words (step S100). Next, the clustering unit 103 clusters the gathered words (step S200). At this time, the clustering unit 103 records the words computed for clustering and the degree of unity between words in the unity-between-words memory unit 302. Furthermore, the type determination unit 104 determines whether or not the cluster is composed of words similar to the seed words, for each cluster (step S300). Then, the re-execution unit 202 groups the gathered words (step S330). Then, when there are ungathered groups (step S360: Yes), the process of selecting seed words from the ungathered groups and gathering the words is repeated, and when there are no ungathered groups (step S360: No), the process ends.

In this manner, with this preferred embodiment the words in the group are not selected at random, as words are selected giving consideration to the degree of unity between words. Accordingly, word gathering in response to various circumstances is possible.

The above-described preferred embodiments may have various forms and applications.

For example, with the above-described preferred embodiments, a word is extracted from a document stored in the document memory unit 106, but this is not intended to be limiting, for words may also be extracted from Web pages on the Internet using an Internet search engine.

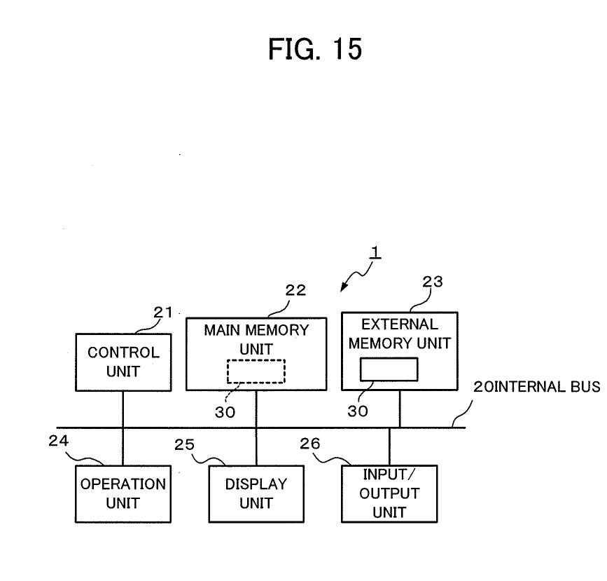

FIG. 15 is a block diagram showing one example of the physical composition when the dictionary creation devices 100, 200 and 300 according to the preferred embodiments of the present invention are implemented on a computer. The dictionary creation devices 100, 200 and 300 according to the preferred embodiments of the present invention can be realized by the same hardware composition as a typical computer device. The dictionary creation devices 100, 200 and 300 are provided with a control unit 21, a main memory unit 22, an external memory unit 23, an operation unit 24, a display unit 25 and an input/output unit 26. The main memory unit 22, external memory unit 23, operation unit 24, display unit 25 and input/output unit 26 are all connected to the control unit 21 via an internal bus 20.

The control unit 21 is composed of a CPU (Central Processing Unit) and/or the like and executes the dictionary creation process in the above-described preferred embodiments in accordance with a control program stored in the external memory unit 23.

The main memory unit 22 is composed of a RAM (Random-Access Memory) and/or the like and loads the control program 30 stored in the external memory unit 23, and is used as a work area for the control unit 21.

The external memory unit 23 is composed of non-volatile memory such as flash memory, a hard disk, DVD-RAM (Digital Versatile Disc Random-Access memory), DVD-RW (Digital Versatile Disc ReWritable) and/or the like, and stores in advance the control program 30 for causing the control unit 21 to execute the above-described processes. In addition, the external memory unit 23 supplies data this control program 30 stores to the control unit 21 in accordance with instructions from the control unit 21, and stores the data supplied from the control unit 21. In addition, the external memory unit 23 physically realizes the document memory unit 106, the gathering process memory unit 107, the gathered word memory unit 108, the word group memory unit 203 and the unity-by-word memory unit 302 in the above-described preferred embodiments.

The operation unit 24 is composed of a keyboard and a pointing device such as a mouse and/or the like, and an interface device and/or the like connecting the keyboard and pointing device and/or the like to the internal bus 20. Seeds words and instructions to start the dictionary creation process are supplied to the control unit 21 via the operation unit 24.

The display unit 24 is composed of a CRT (Cathode Ray Tube) or an LCD (Liquid Crystal Display) and/or the like, and displays various information. For example, the display unit 25 displays the various gathered words with information about whether they are similar or dissimilar to the seed words appended, for each cluster.

The input/output device 26 is composed of a wireless transceiver, a wireless modem or a network terminus device, and a series interface or LAN (Local Area Network) interface and/or the like connected to such. For example, words may be gathered from Web pages on the Internet via the input/output unit 26.

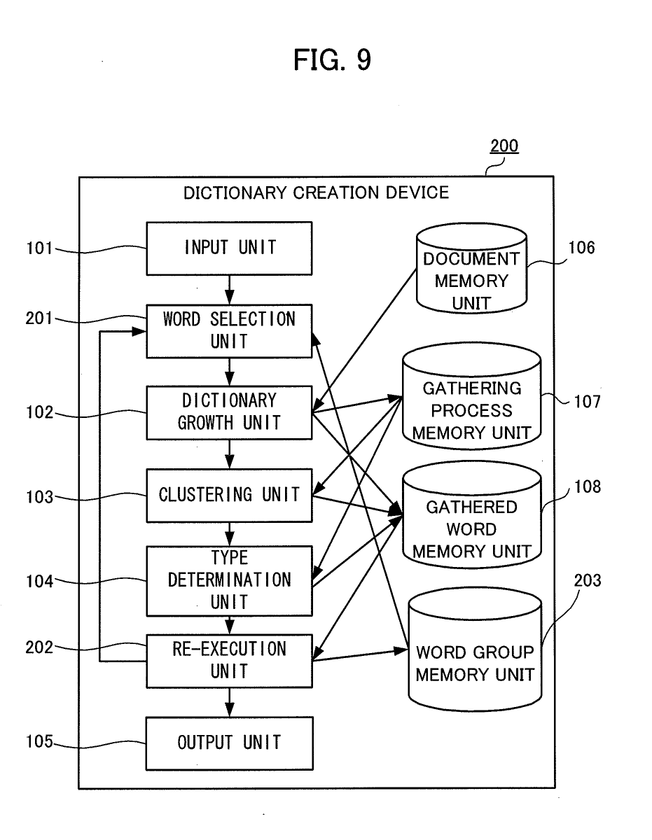

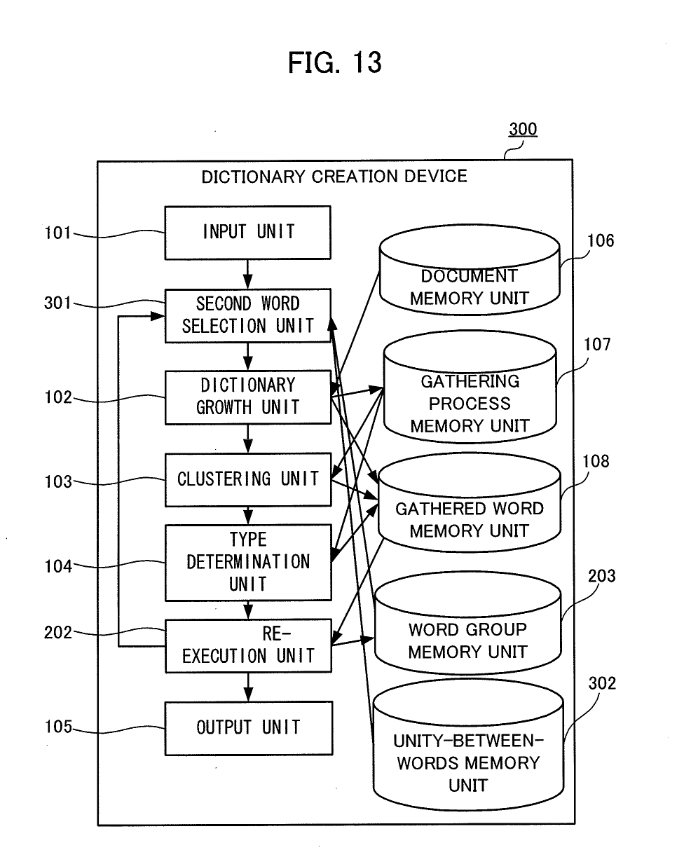

The processes of the dictionary growth unit 102, the clustering unit 103, the type determination unit 104, the output unit 105, the word selection unit 201, the re-execution unit 202 and the second word selection unit 301 of the dictionary creation devices 100, 200 and 300 shown in FIGS. 1, 9 and 13 are executed by the control program 30 processing using as resources the control unit 21, the main memory unit 22, the external memory unit 23, the operation unit 24, the display unit 25 and the input/output unit 26.

The above-described hardware composition and flowcharts are one example, and this can be altered or modified at will.

In addition, the central part for accomplishing the processes of the dictionary creation devices 100, 200 and 300 composed of the control unit 21, the main memory unit 22, the external memory unit 23, the operation unit 24, the input/output unit 26 and the internal bus 20 and/or the like need not be a specialized system but can be realized using a normal computer system. For example, the dictionary creation devices 100, 200 and 300 for executing the above-described processes may be composed by storing and distributing the computer program for executing the above actions on a computer-readable storage recording medium (flexible disc, CD-ROM, DVD-ROM and/or the like) and by installing this computer program on a computer. In addition, the dictionary creation devices 100, 200 and 300 may be composed by storing the computer program on a memory device possessed by a server device on a communication network such as the Internet and/or the like and having a normal computer system download such.

In addition, when the functions of the dictionary creation devices 100, 200 and 300 are realized through division of responsibility between an OS (operating system) and application programs, or through cooperation between an OS and application programs, it is fine to store only the application program part on a recording medium or storage device

In addition, it is possible to superimpose a computer program on carrier waves and distribute such via a communication network. For example, it would be fine to distribute the above-described computer program via a network by posting the above-described computer program on a bulletin board system (BBS) on a communication network. Furthermore, it would be fine to have a composition such that the above-described processes can be executed by launching this computer program and similarly executing other application programs under the control of the OS.

This application claims the benefit of Japanese Patent Application 2009-282304, filed 11 Dec. 2009, the entire disclosure of which is incorporated by reference herein.

### DESCRIPTION OF REFERENCE NUMERALS

100 Dictionary creation device

101 Input unit

102 Dictionary growth unit

103 Clustering unit

104 Type determination unit

105 Output unit

106 Document memory unit

107 Gathering process memory unit

108 Gathered word memory unit

1. A dictionary creation device, comprising:
an input/output process recording means for recording information indicating the process of inputting and outputting input words and output words output by the input words, in a dictionary growth process for gathering words by repeatedly accepting input of words, outputting words related to the input words from document data, adding to the input words words output until a prescribed condition is satisfied, and outputting words related to the input words from document data;
a cluster classifying means for classifying words that input word or output word becomes the same into same cluster among words gathered by the dictionary growth process based on information recorded in the input/output process recording means;
a similarity determining means for determining whether or not words in a cluster are words of the same type as input words for which input was initially received, for each cluster classified by the cluster classifying means, based on the number of turns required to output each word in the cluster from the input word, by referencing information recorded in the input/output process recording means; and
a gathered word output means for linking together and outputting words gathered by the dictionary growth process, clusters to which the words belong and information indicating whether or not the words comprising the cluster are words of the same type of the input words for which input was initially received.

2. The dictionary creation device of claim 1, further comprising a dictionary growth means for gathering words by repeatedly accepting input of words, outputting words related to the input words from document data, adding to the input words words output until a prescribed condition is satisfied, and outputting words related to the input words from document data.

3. The dictionary creation device of claim 1, wherein the input/output process recording means records information indicating the input/output process of input words and output words output by the input words, with input and output repeated multiple times.

4. The dictionary creation device of claim 1, wherein the cluster classifying means calculates a degree of unity between words indicating a value that becomes larger between words which have common words as inputs or between words that output common words in the above-described dictionary growth process, out of the words gathered in the dictionary growth process, from information recorded in the input/output process registration means, and classifies words into clusters based on the calculated degree of unity.

5. The dictionary creation device of claim 1, wherein the similarity determining means calculates an average value for words in a cluster of the minimum number of inputs/outputs for a word in the cluster to input/output an input word the input of which is initially received, for each cluster, based on information recorded in the input/output process recording means, and determines that words are of the same type when the calculated average value is not greater than a prescribed threshold value.

6. The dictionary creation device of any of claim 1, further comprising:
a word group memory means for classifying words gathered by the dictionary growth process into multiple word groups, for each type, and storing such; and
a word selecting means for selecting a prescribed number of words from one word group meeting prescribed conditions;
wherein the dictionary growth process is executed using the words selected by the word selecting means as input words; and
the similarity determining means determines whether or not words in a cluster are the same type of words as the input words selected by the word selecting means, for each cluster classified by the cluster classifying means, based on information recorded in the input/output process recording means.

7. The dictionary creation device of claim 6, further comprising a re-execution means for recording words gathered by the dictionary growth process in the word group memory means, based on results determined by the similarity determining means, and instructing the word selecting means to select words when there is a word group satisfying prescribed conditions out of the recorded word groups;
wherein when recording the gathered words in the word group memory means, when the cluster to which the gathered words belong is the same type of word as the word selected by the word selecting means, the re-execution means records the gathered words in the same word group as the selected word, and when the word is a different type and has already been stored in the word group memory means, records the gathered words in the same word group as the stored words, and when the word is of a different type and has not yet been stored in the word group memory means, records the gathered word in a new word group.

8. The dictionary creation device of claim 6, further comprising a degree-of-unity memory means for storing a degree of unity between words indicating a value that becomes larger between words which have common words as inputs or between words that output common words in the above-described dictionary growth process, and that is computed from information recorded in the input/output process recording means;
wherein the word selecting means selects a prescribed number of words based on the degree of unity between words in the one word group.

9. The dictionary creation device of claim 8, wherein the word selecting means selects a prescribed number of words based at least on condition information in which at least the ratio for selecting words in decreasing order of degree or unity or the ratio of selecting words in increasing order of degree of unity is preset.

10. A word gathering method, comprising:
an input/output process recording step for recording information indicating the process of inputting and outputting input words and output words output by the input words, in a dictionary growth process for gathering words by repeatedly accepting input of words, outputting words related to the input words from document data, adding to the input words words output until a prescribed condition is satisfied, and outputting words related to the input words from document data;
a cluster classifying step for classifying words that input word or output word becomes the same into same cluster among words gathered by the dictionary growth process based on information recorded in the input/output process recording step;
a similarity determining step for determining whether or not words in a cluster are words of the same type as input words for which input was initially received, for each cluster classified by the cluster classifying step, based on the number of turns required to output each word in the cluster from the input word, by referencing information recorded in the input/output process recording step; and
a gathered word output step for linking together and outputting words gathered by the dictionary growth process, clusters to which the words belong and information indicating whether or not the words comprising the cluster are words of the same type of the input words for which input was initially received.

11. A computer-readable recording medium on which is recorded a program that causes a computer to function as:
an input/output process recording means for recording information indicating the process of inputting and outputting input words and output words output by the input words, in a dictionary growth process for gathering words by repeatedly accepting input of words, outputting words related to the input words from document data, adding to the input words words output until a prescribed condition is satisfied, and outputting words related to the input words from document data;
a cluster classifying means for classifying words that input word or output word becomes the same into same cluster among words gathered by the dictionary growth process based on information recorded in the input/output process recording means;
a similarity determining means for determining whether or not words in a cluster are words of the same type as input words for which input was initially received, for each cluster classified by the cluster classifying means, based on the number of turns required to output each word in the cluster from the input word, by referencing information recorded in the input/output process recording means; and
a gathered word output means for linking together and outputting words gathered by the dictionary growth process, clusters to which the words belong and information indicating whether or not the words comprising the cluster are words of the same type of the input words for which input was initially received.
